(19) United States
(12) Patent Application Publication
(10) Pub. No.: US 2025/0133082 A1
(43) Pub. Date: Apr. 24, 2025

(54) ENABLING AUTHENTICATION BY A LOCAL IDENTITY PROVIDER WHEN CLOUD-BASED AUTHENTICATION IS UNAVAILABLE

(71) Applicant: Aveva Software, LLC, Lake Forest, CA (US)

(72) Inventors: Nausheen Kareem, Rancho Santa Margarita, CA (US); Dimitre Ivanov, Mission Viejo, CA (US); Douglas Kane, Vashon, WA (US)

(21) Appl. No.: 18/923,431

(22) Filed: Oct. 22, 2024

Related U.S. Application Data
(60) Provisional application No. 63/545,262, filed on Oct. 23, 2023.

(51) Int. Cl. H04L 9/40

(52) U.S. Cl. CPC H04L 63/0884

(57) ABSTRACT

After receiving a request to authenticate a user of a system, which is local to the user and connected to a cloud's platform, the cloud's local identity provider authenticates the user based on identifying the user's cloud identity from cloud identities associated with subscriptions to access an application. The cloud's usage service authorizes the cloud-authenticated user to access the application based on the subscription associated with the user's cloud identity. The system matches the user's system identity with the user's cloud identity. If the system is not connected to the cloud's platform, the system's identity manager authenticates the user based on identifying the user's system identity from system identities matched with cloud identities. The system's usage service authorizes the system-authenticated user to access the application based on the subscription associated with the cloud identity matched with the user's system identity.

### CROSS REFERENCE TO RELATED APPLICATION

This application claims priority under 35 U.S.C. § 119 or the Paris Convention from U.S. Provisional Patent Application 63/545,262, filed Oct. 23, 2023, the entire contents of which is incorporated herein by reference as if set forth in full herein.

### BACKGROUND

Modern industrial software applications need to be able to execute in a hybrid environment where critical control processes are executed on a local system, which may be referred to as an on-premises system, site, or facility, but the user configurations and application configurations are maintained in the cloud. After a cloud-hosted process establishes a user's identity through authentication, such a hybrid application needs to use the authenticated user identity to authorize the user's access, which may be referred to as an access level, an authorization role, or an entitlement to both on-premise and cloud resources. In such an operational environment, Human Machine Interface (HMI) and AVEVA Operations Control Products systems must be highly available. When using cloud-based authentication and/or authorization, which is valuable for centralized management and access to cloud products such as Software as a Service (SaaS), a key concern is what happens when a site loses connectivity to the cloud.

An operational risk is created if operators at an isolated site can no longer login to an on-premises system due to a connectivity failure, which may be due to a loss of the on-premises system's connection to the system's network, to the Internet, to a cloud platform, and/or to cloud resources. On-premises system components must be able to continue to execute when such connections are temporarily lost, in order to continue control of mission critical applications. It is a major concern in the industry that such on-premises systems must have internet/cloud connectivity to perform user authentication and user authorization. Any loss of user authentication and/or user authorization can leave such on-premises systems as non-operational and cause safety issues and loss of production.

### BRIEF DESCRIPTION OF THE DRAWINGS

FIG. 1 illustrates an example workflow for enabling authentication by a local identity provider when cloud-based authentication is unavailable, according to embodiments.

FIG. 2 illustrates example system components and services for enabling authentication by a local identity provider when cloud-based authentication is unavailable, according to embodiments.

FIG. 3 illustrates a block diagram of an example system for enabling authentication by a local identity provider when cloud-based authentication is unavailable, according to embodiments.

FIG. 4 is a flowchart that illustrates a computer-implemented method for enabling authentication by a local identity provider when cloud-based authentication is unavailable, according to embodiments.

FIG. 5 is a block diagram illustrating an example hardware device in which the subject matter may be implemented.

### DETAILED DESCRIPTION

After a cloud identity provider successfully authenticates a user based on the user's cloud identity, an on-premises system caches the user's cloud identity. Similarly, after a cloud usage service successfully authorizes a user to access an application based on the user's subscription to the application, the on-premises system caches the user's subscription information. Consequently, when the on-premises system loses a connection with a network, internet. cloud platform, and/or cloud resource, the on-premises system can use the cached user information to provide user authentication and the user's cached subscription information to provide authorization checks and thereby maintain plant-floor operations. Embodiments of this disclosure enable reliable operations by providing fallback authentication and authorization by a local (on-premises) identity provider when cloud-based authentication is unavailable, thereby ensuring a highly available authentication and authorization capability.

In embodiments, after receiving a request to authenticate a user of a system, which is connected to a cloud's platform, the cloud's identity provider authenticates the user based on identifying the user's cloud identity from cloud identities associated with subscriptions to access an application. The cloud's usage service authorizes the cloud-authenticated user to access the application based on the subscription associated with the user's cloud identity. The system matches the user's system identity with the user's cloud identity. If the system is not connected to the cloud's platform, the system's identity provider authenticates the user based on identifying the user's system identity from system identities matched with cloud identities. The system's usage service authorizes the system-authenticated user to access the application based on the subscription associated with the cloud identity matched with the user's system identity.

For example, Sue is a supervising user for Acme Corporation, and she requests access to an AVEVA Operations Control Products system application, which requests the authentication of Sue from an on-premise's AVEVA Identity Manager, which confirms a cloud connection to the AVEVA Connect cloud identity provider. Then the on-premise's AVEVA Identity Manager conveys the authentication request to the AVEVA Connect cloud identity provider, which searches the cloud user identities and subscriptions for Acme's employees, and identifies a cloud user identity for Sue. The AVEVA Connect cloud identity provider responds by providing an AVEVA Connect access token with Sue's cloud user identity to the on-premise's AVEVA Identity Manager, which embeds the AVEVA Connect access token in its own token, and caches Sue's cloud user identity in an on-premises cache. Next, the on-premise's AVEVA Identity Manager conveys the combined tokens to the AVEVA Operations Control Products system application, which returns the combined tokens in a request to authorize Sue to access the AVEVA Operations Control Products system application, which is received by an on-premises' usage service which confirms a cloud connection to a cloud usage service.

Then the on-premise's usage service conveys the authorization request to a cloud usage service, which requests the authorization through the AVEVA Connect cloud identity provider, which searches the cloud user identities and subscription for Acme's employees, and identifies Sue's subscription to the AVEVA Operations Control Products system application. In response to the AVEVA Connect cloud identity provider providing Sue's subscription, the cloud usage service conveys Sue's subscription to the on-premise's usage service, which caches Sue's subscription in an on-premises usage cache. Next, the on-premise's AVEVA Identity Manager matches Sue's on-premise's user identity, AcmeCoDomain\SueSuper, with Sue's cloud user identity, SueSuper@ AcmeCo. Since each cloud user identity is already linked with its subscription, matching a user's on-premise's user identity with the user's cloud user identities results in indirectly linking the user's on-premise's user identity with its subscriptions, such as linking AcmeCoDomain\SueSuper with Sue's subscription to access the AVEVA Operations Control Products system application to which Acme subscribes.

Continuing the example, Mary is a managing user for Acme Corporation, and she requests access to the AVEVA Operations Control Products system application, which requests the authentication of Mary from the on-premise's AVEVA Identity Manager, which determines that the cloud connection is lost to the AVEVA Connect cloud identity provider. Therefore, the on-premise's AVEVA Identity Manager searches an on-premises' Active Directory that cached cloud user identities for Acme's employees, and identifies a cloud user identity for Mary that was previously matched with the on-premises' user identify for Mary the last time that Mary used the on-premises' system when connected to the cloud. The on-premises' system gets the AVEVA Identity Manager's token which was cached, and conveys the token to the AVEVA Operations Control Products system application, which returns the token in a request to authorize Mary to access the AVEVA Operations Control Products system application, which is received by the on-premises' usage service which determines that the cloud connection is lost to the cloud usage service.

Therefore, the on-premise's usage service searches the on-premises' cache which caches Mary's subscriptions. The on-premise's AVEVA Identity Manager matched Mary's on-premise's user identity, AcmeCoDomain\MaryManager, with Mary's cloud user identity, MaryManager@AcmeCo, such that AcmeCoDomain\MaryManager is now indirectly linked with Mary's subscription to access the AVEVA Operations Control Products system application. The AVEVA Identity Manager enables Mary to access the AVEVA Operations Control Products system application even though MaryManager@AcmeCo, which is the indirect link between AcmeCoDomain\MaryManager and Mary's subscription to access the AVEVA Operations Control Products system application, is currently unavailable though the AVEVA Connect cloud identity provider.

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Although these embodiments are described in sufficient detail to enable one skilled in the art to practice the disclosed embodiments, it is understood that these examples are not limiting, such that other embodiments may be used, and changes may be made without departing from their spirit and scope. For example, the operations of methods shown and described herein are not necessarily performed in the order indicated and may be performed in parallel. It should also be understood that the methods may include more or fewer operations than are indicated. In some embodiments, operations described herein as separate operations may be combined. Conversely, what may be described herein as a single operation may be implemented in multiple operations.

Reference in the specification to “one embodiment” or “an embodiment” or “some embodiments,” means that a particular feature, structure, or characteristic described in conjunction with the embodiment may be included in at least one embodiment of the disclosure. The appearances of the phrase “an embodiment” or “the embodiment” in various places in the specification do not necessarily all refer to the same embodiment.

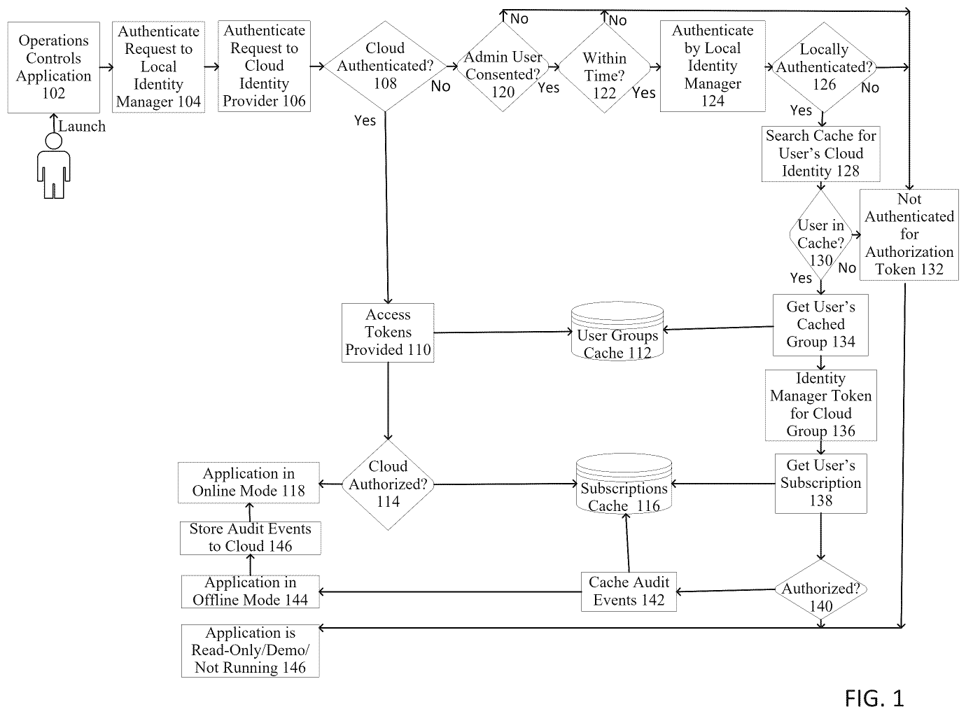

FIG. 1 illustrates an example workflow 100 for enabling authentication by a local identity provider when cloud-based authentication is unavailable, according to embodiments. The workflow 100 includes the workflow blocks 102-108 which summarize the common workflow of an on-premises system, the workflow blocks 110-118 and 148 that summarize the workflow branch when the on-premises system is connected to the cloud, and the workflow blocks 120-146 that summarize the workflow branch when the on-premises system is not connected to the cloud. In block 102, a user launches an operations control application, such as the AVEVA Operations Control Products system application. Block 104 summarizes the application sending a request to authenticate the user to a local identity manager, such as an on-premises AVEVA identity manager. The local identity manager conveys the request to authenticate the user to a cloud identity provider, such as the AVEVA Connect cloud identity provider, in block 106. Then block 108 determines if the user was cloud authenticated, which ends the common workflow and either begins the workflow branch when the on-premises system is connected to the cloud or the workflow branch when the on-premises system is not connected to the cloud.

If the system is connected by the cloud, the cloud authenticated the user, and the workflow 100 begins the workflow branch blocks 110-118 when the on-premises system is connected to the cloud, by continuing to block 110, where access tokens are provided, by the cloud identity provider and the local identity manager. In block 112, the cloud-authenticated user's cloud tokens and cloud identifier are parts of the user's cloud information that is cached locally for future local authentication when the system is not connected to the cloud. The workflow 110 resumes in block 114, where the application sends the tokens with a request to authorize the user, which the local identity manager conveys to the cloud identity provider, which authorizes the user to access the application based on the user's subscription to the application. In block 116, the user's subscription to the application is cached locally for future local authorization when the system is not connected to the cloud. The workflow 100 resumes by reaching one of the endpoints in block 118, where the cloud-authenticated and authorized user has subscription-based access to the application which is in online mode.

If the system is not connected by the cloud, the cloud did not authenticate the user, and the workflow 100 begins the workflow branch blocks 120-146 when the on-premises system is not connected to the cloud, by continuing to block 120, which asks whether an administrative user consented to having the user's authentication processed by a local identity manager. An administrative user is required to have provided explicit consent to enable the user's on-premises system's authentication. If an administrative user explicitly consented to having the user's authentication processed by a local identity manager, the workflow 100 continues to block 122 to determine whether the administrative user's explicit consent occurred within the allowed time. If an administrative user did not explicitly consent to having the user's authentication processed by a local identity manager, the workflow 100 proceeds to block 132, where a conclusion is drawn that no authentication was made for an authorization token. In block 122, the local system determines whether an administrative user's explicit consent occurred within the allowed time. The on-premises system may be enabled to authenticate the user for an allowed time after an administrative user's explicit consent for local authentication, such as 30 days after the administrative user's explicit consent.

If an administrative user's explicit consent occurred within the allowed time, the workflow 100 continues to block 124 to authenticate the request by the identity manager. If an administrative user's explicit consent did not occur within the allowed time, the workflow 100 proceeds to block 132 where a conclusion is drawn that no authentication was made for an authorization token. In block 124, the on-premises identity manager attempts to authenticate the user. A determination is made in block 126 whether the user was authenticated locally. If the user was authenticated locally, the workflow 100 proceeds to block 128 to use the local identity authenticated for the user to search the cache for a matching cloud identity for the user.

In block 130, a determination is made whether a matching cloud identity was found for the user in the cache. If a matching cloud identity was not found for the user in the cache, the workflow 100 continues to block 132 where a conclusion is drawn that no authentication for an authorization token would be possible. If a matching cloud identity was found for the user in the cache, the workflow 100 proceeds to block 134 where the matching cloud identity is used to get the user's cached cloud information, which is cached in any user group(s). In block 132, a conclusion is drawn that no authentication for an authorization token would be possible, such that even if a local authentication of the user is made, the lack of a cloud identity which corresponds to the local identity from the local authentication means that there will be no access token available which corresponds to the user's cloud identity, and such an access token is required to authorize the user's access to the application. Therefore, after block 132 draws the conclusion that there will be no access token available, the workflow 100 proceeds to block 146, where the targeted application is put in the read only/demonstration, or not running mode, which is the other endpoint for the workflow 100.

In block 134, the user's matching cloud identity is used to get the user's matching cloud information from the user groups cache 112, which stores the cloud access tokens, the corresponding users' cloud identities, and any other cloud information for the user. The access token that is generated by the local identity manager is expected to have embedded a token generated by the cloud identity provider. However, the cloud identity provider may not be available for generating such a token to be embedded in the token that is being generated by the local identity manager. Therefore, in this situation, the local identity manager collects the information that the cloud identity provider would have collected for storing into the token which would have been generated by the cloud identity provider.

Therefore, in block 136 the system identifies the relevant identity provider token from the user cloud group that corresponds to the user's cloud identifier, which is the cloud token that enables the authorization of access to the targeted application. In block 138, the cloud token is used to get the user's subscription information and any other of the user's cloud information from the subscriptions cache 116. Block 140 summarizes using the user's subscription information to determine if the user is authorized to access the targeted application.

If the user is authorized to access the targeted application, the workflow 100 continues to block 142 where the user accesses the application and the system caches the audit events from the user's access of the application. If the user is not authorized to access the targeted application, the workflow proceeds to block 146, where the targeted application is put in the read only/demonstration, or not running mode, which is one of the endpoints for the workflow 100. After caching the audit events in block 142, while waiting for the connection to the cloud to be restored, the application is in offline mode, as summarized in block 144. When the connection is restored, the audit events are stored to the cloud in block 146, and the workflow 100 reaches one of the endpoints in block 118, where the cloud-authenticated and authorized user has subscription-based access to the application which is in online mode.

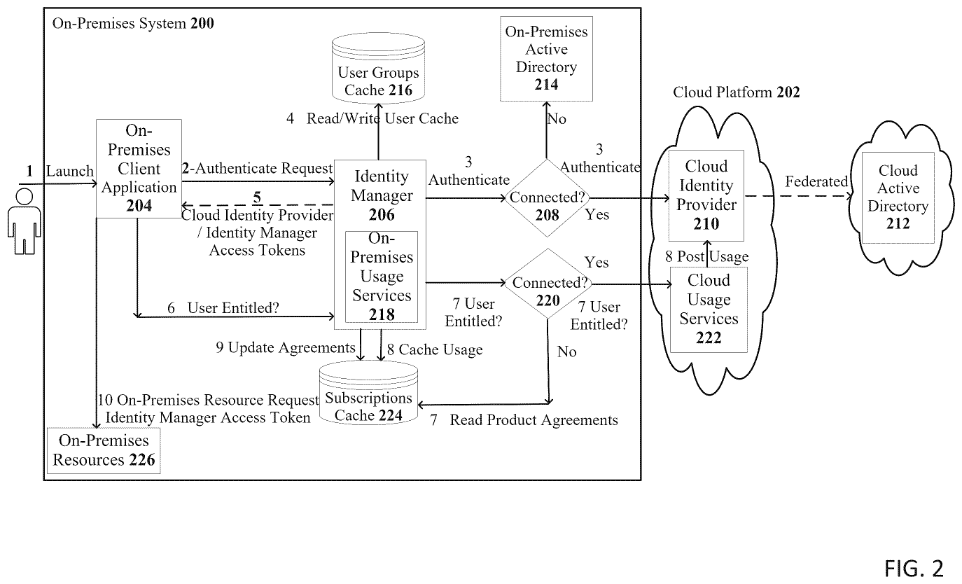

FIG. 2 illustrates example system components and services for enabling authentication by a local identity provider when cloud-based authentication is unavailable, according to embodiments. An on-premises system 200 and a cloud platform 202 communicate with each other and include various components and services that participate in interactions that provide cloud authentication and authorization when the on-premises system 200 is connected to the cloud platform 202 and enable local authentication and authorization when the on-premises system 200 is not connected to the cloud platform 202. A user 1 launches an on-premises client application 204, which may be the AVEVA Operations Control Products system application, or other AVEVA applications such as InTouch, System Platform, and MES. The on-premises client application 204 sends a 2 authentication request on behalf of the user to an identity manager 206, which may be an AVEVA identity manager.

If the on-premises system 202 is connected 208 to the cloud platform 204, the identity manager 206 redirects the 3 authentication request to the cloud identity provider 210, which may be the AVEVA Connect cloud identity provider, which authenticates the user against the cloud active directory 212. If the 3 authentication is successful, the identity manager 206 receives access tokens from the cloud identity provider 210. If the on-premises system 200 is not connected 208 to the cloud platform 202, the identity manager 206 authenticates the user against the on-premises active directory 214. If the user was authenticated by the cloud identity provider 210 against the cloud active directory 212, the identity manager 206 4 writes the user's cloud information to the user groups cache 216. If the user was authenticated against the on-premises active directory 214, the identity manager 206 matches the user's local identity to the user's cloud identity (by email or “onprem_sid” property) and reads the user's cloud information from the users groups cache 216.

The identity manager 206 returns 5 cloud identity provider/identity manager access tokens to the on-premises client application 204. If the user was authenticated by the cloud identity provider 210 against the cloud active directory 212, the identity manager token has an embedded cloud identity provider token. If the user was authenticated against the on-premises active directory 214, the identity manager token does not have an embedded cloud identity provider token.

The access token that is generated by the local identity manager 206 is expected to have embedded a token generated by the cloud identity provider 210. However, the cloud identity provider 210 may not be available for generating such a token to be embedded in the token that is being generated by the local identity manager 206. Therefore, in this situation, the local identity manager 206 collects the information that the cloud identity provider 210 would have collected for storing into the token which would have generated by the cloud identity provider 210.

The on-premises client application 204 determines whether the user is authorized to access the on-premises client application 204 by calling a 6 User Entitled? application programming interface (API) of an on-premises usage service 218, and passing the user's access token. If the on-premises system 200 is connected 220 to the cloud platform 202, and if a cloud identity provider token is embedded in the identity manager token, then the on-premises usage service 218 calls the cloud usage service 222 to authorize the user by responding to 7 User Entitled? application programming interface. If the on-premises system 200 is not connected 220 to the cloud platform 202, or if a cloud identity provider token is not embedded in the identity manager token, then the on-premises usage service 218 7 reads product agreements from the subscriptions cache 224 and determines if the user's account has a valid subscription to the on-premises client application 204 and therefore if the user is entitled to access the on-premises client application 204.

If the on-premises system 200 is connected 220 to the cloud platform 202, and if a cloud identity provider token is embedded in the identity manager token, then the cloud usage service 222 posts 8 usage of the on-premises client application 204 by the cloud-authorized user to the cloud identity provider 210. If the on-premises system 200 is not connected 220 to the cloud platform 202, or if a cloud identity provider token is not embedded in the identity manager token, then the then the on-premises usage service 218 caches 8 usage of the on-premises client application 204 by the locally-authorized user to the subscriptions cache 224, so that when the on-premises system 200 is reconnected 220 to the cloud platform 202, this usage can be submitted to the cloud usage service 222 which posts 8 usage of the on-premises client application 204 by the locally-authorized user to the cloud identity provider 210. The on-premises system 200 will cache all on-premises system's authorization checks of users until connectivity to the cloud platform 202 is restored, and then will store the on-premises system's authorization checks of users to the cloud usage service 222 and/or the cloud identity provider 210.

If the cloud usage service 222 used the cloud identity provider 210 to authorize the user, which may be referred to as an entitlement validation or check, in a successful response to 7 User Entitled? application programming interface, the on-premises usage service 218 9 updates agreements in the subscriptions cache 224. The on-premises client application 204 can make 10 on-premises resource requests by passing the access token from the identity manager 206 to on-premises resources 226.

The on-premises client application 204 may be any configuration or runtime application launched by the user, such as App Server IDE, Window Maker, Window Viewer, OMI Viewer, Edge IDE, etc. Upon being launched by a user in the AVEVA Operations Control connected experience mode, the on-premises client application 204 requires that the user be authenticated. If the user had already been authenticated on the device hosting the on-premises client application 204, the user will not be asked to login for authentication. Upon successful authentication with the AVEVA Connect cloud identity provider 210, the on-premises client application 204 receives access and refresh tokens from the AVEVA identity manager 206, which generates an access token that embeds an access token generated by the AVEVA Connect cloud identity provider 210. Upon successful local authentication by the AVEVA identity manager 206, the on-premises client application 204 receives access and refresh tokens from the AVEVA identity manager 206, which generates an access token which does not embed an access token generated by the AVEVA Connect cloud identity provider 210.

The on-premises client application 204 periodically calls the AVEVA identity manager 206 to refresh the access tokens. The on-premises client application 204 displays information such as a user profile, authentication and connection status, application connectivity to both the AVEVA identity manager 206 and the AVEVA Connect cloud identity provider 210, application connectivity to only the AVEVA identity manager 206, and/or application disconnected from the AVEVA identity manager 206.

The AVEVA identity manager 206 is the local identity provider for all on-premises products, and federates user authentication with the AVEVA Connect cloud identity provider 210. Upon successful user authentication with the AVEVA Connect cloud identity provider 210, the AVEVA identity manager 206 generates access tokens which it returns to registered clients, which embed an access token generated by the AVEVA Connect cloud identity provider 210. Upon successful user authentication with the AVEVA Connect cloud identity provider 210, the AVEVA identity manager 206 caches the on-premise user's configuration from the AVEVA Connect cloud identity provider 210. Upon successful on-premises user authentication, the AVEVA identity manager 206 generates access token which do not embed an access token generated by the AVEVA Connect cloud identity provider 210, which it returns to registered clients.

The on-premises usage service 218 is hosted by the AVEVA identity manager 206, and is responsible for validating entitlement for logged in user's account by using a User Entitled? application programming interface which calls the cloud usage service 222 to authorize the user to access the on-premises client application 204. The on-premises usage service 218 caches account subscription information and entitlement audit events locally when disconnected from the cloud usage service 222, and then when reconnected forwards this cached information to the cloud usage service 222. The cloud usage service 222 exposes APIs to enable entitlement validation for logged in user's account, and to enable reporting of product usage by a user. Similarly, the AVEVA Connect cloud identity provider 210 exposes API's for user management and role/group membership.

The AVEVA Connect cloud identity provider 210 must have authenticated a user at least once for the AVEVA identity manager 206 to have subsequently cached the user's information to the on-premises user groups cache 216 so that the on-premises system 200 will have the cached user information required to locally authenticate the user. If the AVEVA Connect cloud identity provider 210 has not authenticated a user at least once, then the AVEVA identity manager 206 would not have subsequently cached the user's cloud information to the on-premises user groups cache 216. Consequently, the on-premises system 200 would not have the user information required to locally authenticate and/or authorize the user, unless a system administrator accesses the cloud platform 202, creates a copy of the user's cloud information, and manually transfers the copy of the user's cloud information to the on-premises user groups cache 216. Such a manual transfer of the user's cloud information may be referred to as being accomplished by “sneakernet,” which implies that the system administrator was wearing sneakers while manually transferring the copy of the user's cloud information. Similarly, the copy of the user's cloud information may be referred to as being conveyed through a flex portal to be sent to the AVEVA identity manager 206, implying that the system administrator was being flexible in implementing a process that transfers a copy of the user's cloud information from the cloud platform 202 to the on-premises system 200.

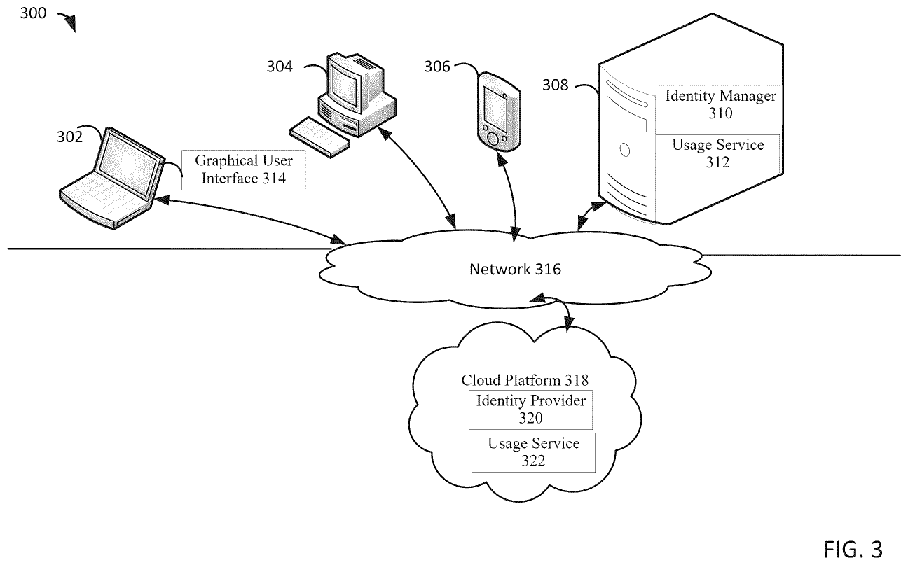

FIG. 3 illustrates a block diagram of an example system 300 for enabling authentication by a local identity provider when cloud-based authentication is unavailable, according to embodiments. As shown in FIG. 3, the system 300 may illustrate a cloud computing environment in which data, applications, services, and other resources are stored and delivered through shared data centers and appear as a single point of access for the users. The system 300 may also represent any other type of distributed computer network environment in which servers control the storage and distribution of resources and services for different client users.

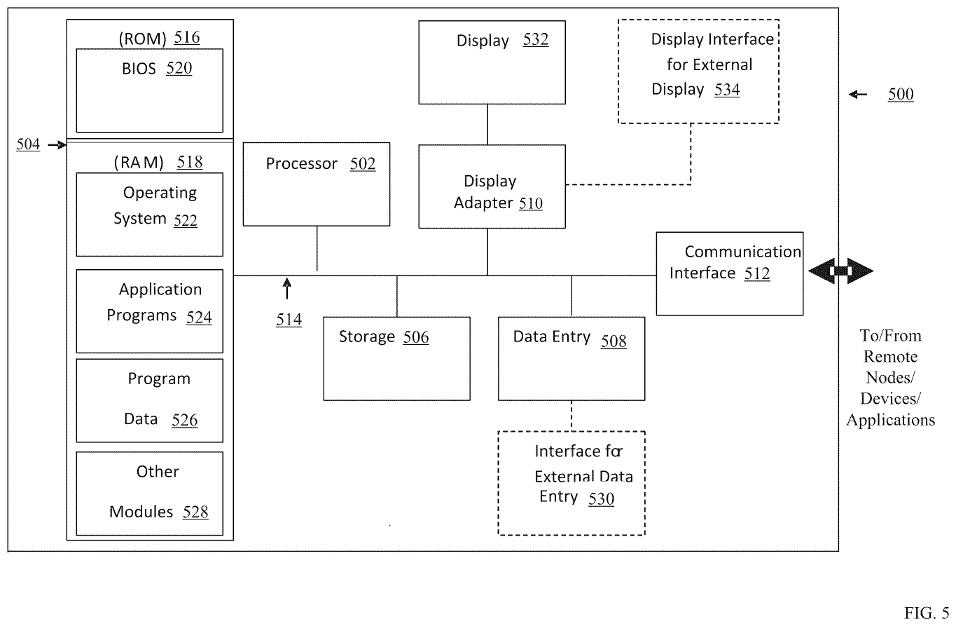

In an embodiment, the system 300 represents a cloud computing system that includes a first client 302, a second client 304, a third client 306, and a server 308 that may be provided by a hosting company. Even though FIG. 3 depicts the first client 302 as a laptop computer 302, the second client 304 as a desktop computer 304, and the third client 306 as a smart phone 306, each of the system components 302-308 may be any type of computer system, and may each be substantially similar to the hardware device 500 depicted in FIG. 5 and described below. The server 308 can host and execute an identity manager 310, which may be an AVEVA identity manager 310, and a usage service 312, which may be accessed via a graphical user interface 314, which may reside on any of the clients 302-306. Although FIG. 3 depicts both the identity manager 310 and the usage service 312 residing completely on the server 308, any or all of the identity manager 310 and the usage service 312 may reside completely on the clients 302-306, or in any combination of partially on the clients 302-306, partially the server 308, and/or partially on another server which is not depicted in FIG. 3.

The clients 302-306 and the server 308 communicate via a network 316 with a cloud platform 318, which can host and execute an identity provider 320, which may be an AVEVA Connect cloud identity provider 320, and a usage service 322, which may be accessed via the graphical user interface 314. FIG. 3 depicts the system 300 with three clients 302-306, one server 308, one identity manager 310, one usage service 312, one graphical user interface 314, and one network 316, and the cloud platform 318 with one identity provider 320 and one usage service 322. However, the system 300 may include any number of clients 302-306, any number of server 308, any number of identity manager 310, any number of usage service 312, any number of graphical user interface 314, and any number of network 316, while the cloud platform 318 may include any number of identity provider 320 and any number of usage service 322.

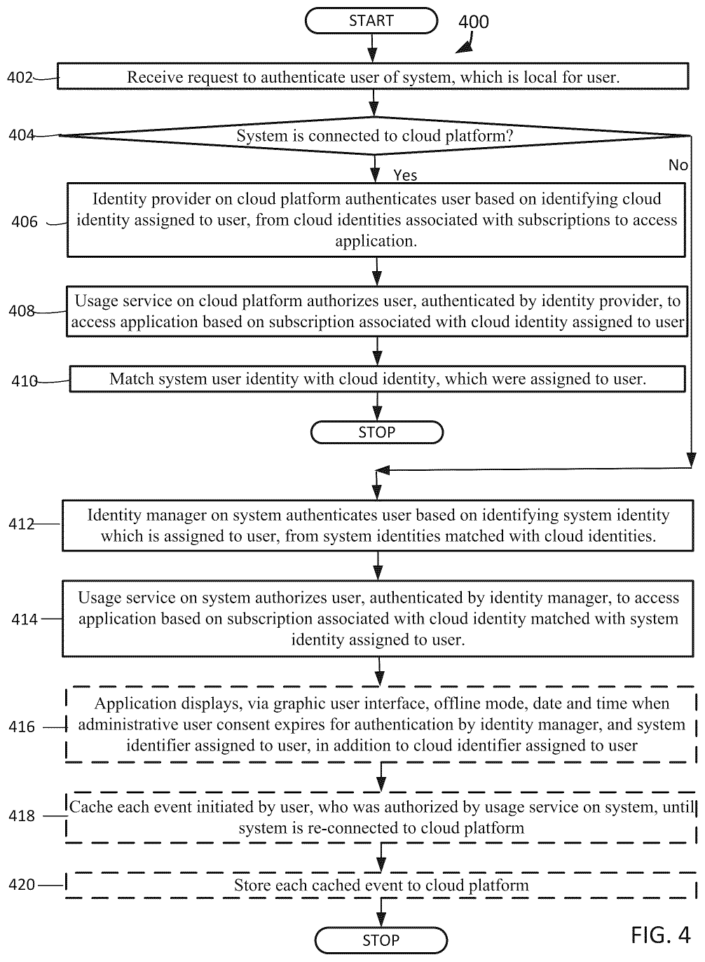

FIG. 4 is a flowchart that illustrates a computer-implemented method for enabling authentication by a local identity provider when cloud-based authentication is unavailable, according to embodiments. Flowchart 400 depicts method acts illustrated as flowchart blocks for certain actions involved in and/or between the system elements 302-322 of FIG. 3.

A request is received to authenticate a user of a system which is local to the user, block 402. The system receives requests to authenticate the identities of local users. For example, and without limitation, this can include the on-premise's AVEVA identity manager 310 receiving an authentication request from an AVEVA Operations Control Products system application, which is conveying a request to authenticate Sue, who is a supervising user for Acme Corporation, which has a subscription to the AVEVA Operations Control Products system application. A request can be a message originated by a client to ask for information to be sent or an action to be performed. A user can be a person who operates a computer. A system can be a combination of hardware, software, and data that work together to perform specific tasks. Local can be accessible without a network.

After receiving a request to authenticate a user of a local system, a determination is made whether the local system is connected to a cloud platform, block 404. The system determines whether cloud resources are available to respond to a request to authenticate the identity of a user. By way of example and without limitation, this can include the on-premise's AVEVA identity manager 310 determining whether the on-premises system 300 has a cloud connection to the AVEVA Connect cloud identity provider 320. A cloud platform can be a collection of servers in a data center that provide computing services to remote customers.

If the local system is connected to a cloud platform, the flowchart 400 continues to block 406 to authenticate the user on the cloud. If the local system is not connected to a cloud platform, the flowchart 400 continues to block 412 to authenticate the user locally.

If the local system is connected to a cloud platform, an identity provider on the cloud platform authenticates the user based on identifying a cloud identity assigned to the user, from cloud identities associated with subscriptions to access an application, block 406. The system uses cloud authentication to determine the identity of a user if cloud authentication is available. In embodiments, this can include the AVEVA Connect cloud identity provider 320 receiving the request to authenticate Sue from the on-premise's AVEVA identity manager 310, searching the cloud user identities and subscriptions for Acme's employees, and identifying a cloud user identity for Sue.

An identity provider can be a source of unique representations of specific people within a collection of remote computers. A cloud identity can be a unique representation of a specific person within a collection of remote computers. A subscription can be a payment model where a user pays a recurring fee to access a product or service for a set period of time. An application can be a software program that helps users perform specific tasks.

Authenticating a user may include providing an access token to an application. For example, the AVEVA Connect cloud identity provider 320 responds to a request to authenticate Sue by providing an AVEVA Connect access token with Sue's cloud information, including her user identity, to the on-premise's AVEVA identity manager 310, which embeds the AVEVA Connect access token in its own token, caches Sue's cloud user identity and her other cloud information in an on-premises cache, and conveys the combined tokens to the AVEVA Operations Control Products application. An access token can be a digital credential that verifies a user's identity and authorizes the user's permissions to view, store, and retrieve resources in a computer system.

A subscription may be based on a user having an individual account and/or a group account subscribed to a product agreement. For example, Sue is a member of a group of supervisors who are subscribed to have supervisor access to the AVEVA Operations Control Products system application. An individual account can be a collection of settings and permissions that are specific to a computer user. A group account can be a collection of computer users, which enables administrators to grant permissions and rights to users simultaneously. A product agreement can be a legal document that outlines the terms and conditions of a transaction between a licensor and a licensee.

Following the authentication of a user by an identity provider, a usage service on a cloud platform authorizes the user to access an application based on the subscription associated with the cloud identity assigned to the user, block 408. The system uses cloud authorization to determine the level of access that an authenticated user has to an application if cloud authorization is available. Authorizing a user to access an application may be based on the application providing an access token. For example, and without limitation, this can include the AVEVA Operations Control Products application returning combined tokens in a request to authorize Sue to access the AVEVA Operations Control Products application, which is received by an on-premises' usage service 312 which confirms a cloud connection to a cloud usage service 322. Then the on-premise's usage service 312 conveys the authorization request to the cloud usage service 322, which requests the authorization through the AVEVA Connect cloud identity provider 320, which searches the cloud user identities and subscription information for Acme's employees, and identifies Sue's subscription to the AVEVA Operations Control Products system application. In response to the AVEVA Connect cloud identity provider 320 providing Sue's subscription information, the cloud usage service 322 conveys Sue's subscription information to the on-premise's usage service 312, which caches Sue's subscription information in an on-premises subscription cache. A usage service can be software that performs automated tasks on behalf of humans interacting with a computer.

Having authorized and authenticated a user on the cloud, a system user identity is matched with a cloud identity, which were assigned to the user, block 410. The system matches users' local and cloud identities to enable local authentication and authorization if cloud authentication and authorization are not available. By way of example and without limitation, this can include the on-premise's AVEVA identity manager 310 matching Sue's on-premise's user identity, AcmeCoDomain\SueSuper, with Sue's cloud user identity, SueSuper@AcmeCo. Since each cloud user identity is already linked with its subscription information, matching a user's on-premise's user identity with the user's cloud user identity results in indirectly linking the user's on-premise's user identity with its subscription information, such as linking AcmeCoDomain\SueSuper with Sue's subscription to access the AVEVA Operations Control Products system application to which Acme subscribes. Then the flowchart 400 terminates. A system user identify can be a unique representation of a specific person, which is within a local computer.

If a local system is not connected to a cloud platform, an identity manager on the local system authenticates a user based on identifying a system identity which is assigned to the user, from system identities matched with cloud identities, block 412. The system uses local authentication to determine the identity of a user if cloud authentication is not available. In embodiments, this can include the on-premise's AVEVA identity manager 310 receiving an authentication request from an AVEVA Operations Control Products system application, which is conveying a request to authenticate Mary, who is a managing user for Acme Corporation, and determining that the on-premises system does not have a cloud connection to the AVEVA Connect cloud identity provider 320. Therefore, the on-premise's AVEVA identity manager 310 searches an on-premises' Active Directory that cached cloud user identities for Acme's employees, and identifies a cloud user identity for Mary that was previously matched with the on-premises' user identify for Mary the last time that Mary used the on-premises' system when connected to the cloud. The on-premises' system 300 gets the AVEVA Identity Manager's token which was cached, and conveys the token to the AVEVA Operations Control Products system application. An identity manager can be a processor of unique representations of specific people, which are within a local computer. A system identity can be a unique representation of a specific person, which is within a local computer.

An identity manager authenticating a user may be based on having received prior consent from an administrative user to be authenticated by the identity manager, and the identity manager authenticating the user within an allowed time. For example, Ann Administrator gave her explicit consent for Mary Manager to be authenticated by the on-premise's AVEVA identity manager 310 when the connection is lost to the AVEVA Connect cloud identity provider 320, and Ann Administrator provided this consent a week ago, which is within the one-month consent expiration time. Prior consent can be permission for something to happen which is granted in advance by a person who operates a computer. An allowed time can be a measure of weeks, days, hours and/or minutes permitted to complete a task.

After a user is authenticated by an identity manager, a usage service on a local system authorizes the user to access an application based on the subscription associated with the cloud identity matched with the system identity assigned to the user, block 414. The system uses local authorization to determine the level of access that an authenticated user has to an application if cloud authorization is not available. For example, and without limitation, this can include the AVEVA Operations Control Products system application returning a token in a request to authorize Mary to access the AVEVA Operations Control Products system application, which is received by the on-premises' usage service 312, which determines that the cloud connection is lost to the cloud usage service 322. Therefore, the on-premise's usage service 312 searches the on-premises' subscription cache which caches Mary's subscription information. The on-premise's AVEVA identity manager 310 matched Mary's on-premise's user identity, AcmeCoDomain\MaryManager, with Mary's cloud user identity, MaryManager@AcmeCo, such that AcmeCoDomain\MaryManager is already indirectly linked with Mary's subscription to access the AVEVA Operations Control Products system application. The AVEVA identity manager 310 enables Mary to access the AVEVA Operations Control Products system application even though MaryManager@AcmeCo, which is the indirect link between AcmeCoDomain\@AcmeCo and Mary's subscription to access the AVEVA Operations Control Products system application, is currently unavailable though the AVEVA Connect cloud identity provider 320.

An example of a data structure used for matching or mapping is illustrated by the table below, which depicts columns that are labeled as Local ID for the on-premise system's local user identities, AVEVA ID for the cloud user identities, and Entitlements for the subscriptions or authorization roles. However, a person having ordinary skill in the art will appreciate that there are many different types of data structures that can retain and enable access to such matching or mapping information.

| Local ID | AVEVA ID | Entitlements |
|---|---|---|
| AcmeCoDomain\SueSuper | SueSuper@AcmeCo | AVEVA Operations Control |
| | | Products system application/ |
| | | supervisor level access |
| AcmeCoDomain\MaryManager | MaryManager@AcmeCo | AVEVA Operations Control |
| | | Products system application/ |
| | | manager level access |
| . . . | . . . | . . . |

Following the authentication of a user, an application optionally displays, via a graphical user interface, an offline mode, a date and a time when an administrative user's consent expires for an authentication by an identity manager, and a system identifier assigned to the user, in addition to a cloud identifier assigned to the user, block 416. The system displays information about whether a user was authenticated and authorized on the cloud or locally. By way of example and without limitation, this can include the graphical user interface 314 displaying that Mary is currently accessing the AVEVA Operations Control Products system application in an offline mode, her local user identity AcmeCoDomain\MaryManager, her cloud user identity MaryManager@AcmeCo, and the three and a half weeks remaining before Ann Administrator's consent for Mary Manager to be authenticated locally will expire. An on-premises client application can use the graphical user interface 314 to display information such as a user profile, authentication and connection status, application connectivity to both the AVEVA identity manager 310 and the AVEVA Connect cloud identity provider 320, application connectivity to only the AVEVA identity manager 310, and/or application disconnected from the AVEVA identity manager 310.

A graphical user interface can be a way for humans to interact with a device through visual elements such as buttons, menus, and icons. An offline mode can be a feature that enables users to access certain functionalities of a software application without an internet connection. A date can be the day of the month or year as specified by a number. A time can be a chronological measurement in hours and minutes, possibly in reference to midnight or noon. A user consent can be permission granted by a person who operates a computer for something to happen. An authentication can be a process that verifies the identity of a user, often before granting access to an information system.

Having authorized a user by a usage service on a local system, each event initiated by the user is optionally cached until the local system is re-connected to a cloud platform, block 418. The system caches a user's locally authorized access to update the history of cloud authorized access when the cloud authorization is available again. In embodiments, this can include the AVEVA identity manager 310 caching a record of Mary's actions accessing the AVEVA Operations Control Products system application that would have been recorded on the cloud for audit purposes if the cloud was available. An event can be an action or occurrence which is triggered by a user, and which a software system recognizes.

After each event initiated by a user is cached, each cached event is optionally stored to a cloud platform, block 420. The system updates the history of cloud authorized access with locally authorized access which occurred when cloud authorization was not available. For example, and without limitation, this can include the AVEVA identity manager 310 transferring a record of Mary's actions accessing the AVEVA Operations Control Products system application, which would have already been recorded on the cloud for audit purposes, and a record of authorizing a user when the cloud becomes available again. A cached event can be an action or occurrence which is triggered by a user, and which a software system recognizes and records.

Although FIG. 4 depicts the blocks 402-420 occurring in a specific order, the blocks 402-420 can occur in another order. In other implementations, each of the blocks 402-420 can also be executed in combination with other blocks and/or some blocks may be divided into a different set of blocks.

An exemplary hardware device in which the subject matter may be implemented shall be described. Those of ordinary skill in the art will appreciate that the elements illustrated in FIG. 5 can vary depending on the system implementation. With reference to FIG. 5, an exemplary system for implementing the subject matter disclosed herein includes a hardware device 500, including a processing unit 502, a memory 504, a storage 506, a data entry module 508, a display adapter 510, a communication interface 512, and a bus 514 that couples elements 504-512 to the processing unit 502.

The bus 514 can comprise any type of bus architecture. Examples include a memory bus, a peripheral bus, a local bus, etc. The processing unit 502 is an instruction execution machine, apparatus, or device and can comprise a microprocessor, a digital signal processor, a graphics processing unit, an application specific integrated circuit (ASIC), a field programmable gate array (FPGA), etc. The processing unit 502 may be configured to execute program instructions stored in the memory 504 and/or the storage 506 and/or received via the data entry module 508.

The memory 504 can include a read only memory (ROM) 516 and a random-access memory (RAM) 518. The memory 504 may be configured to store program instructions and data during operation of the hardware device 500. In various embodiments, the memory 504 can include any of a variety of memory technologies such as static random-access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example.

The memory 504 can also include nonvolatile memory technologies such as nonvolatile flash RAM (NVRAM) or ROM. In some embodiments, it is contemplated that the memory 504 can include a combination of technologies such as the foregoing, as well as other technologies not specifically mentioned. When the subject matter is implemented in a computer system, a basic input/output system (BIOS) 520, containing the basic routines that help to transfer information between elements within the computer system, such as during start-up, is stored in the ROM 516.

The storage 506 can include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 500.

It is noted that the methods described herein may be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like can also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high-definition DVD (HD-DVD™), a BLU-RAY disc; and the like.

A number of program modules may be stored on the storage 506, the ROM 516 or the RAM 518, including an operating system 522, one or more applications programs 526, program data 526, and other program modules 528. A user can enter commands and information into the hardware device 500 through data entry module 508. The data entry module 508 can include mechanisms such as a keyboard, a touch screen, a pointing device, etc.

Other external input devices (not shown) are connected to the hardware device 500 via an external data entry interface 510. By way of example and not limitation, external input devices can include a microphone, joystick, game pad, satellite dish, scanner, or the like. In some embodiments, external input devices can include video or audio input devices such as a video camera, a still camera, etc. The data entry module 508 may be configured to receive input from one or more users of the hardware device 500 and to deliver such input to the processing unit 502 and/or the memory 504 via the bus 514.

A display 512 is also connected to the bus 514 via the display adapter 510. The display 512 may be configured to display output of the hardware device 500 to one or more users. In some embodiments, a given device such as a touch screen, for example, can function as both the data entry module 508 and the display 512. External display devices can also be connected to the bus 514 via the external display interface 534. Other peripheral output devices, not shown, such as speakers and printers, may be connected to the hardware device 500.

The hardware device 500 can operate in a networked environment using logical connections to one or more remote nodes (not shown) via the communication interface 512. The remote node may be another computer, a server, a router, a peer device or other common network node, and typically includes many or all of the elements described above relative to the hardware device 500. The communication interface 512 can interface with a wireless network and/or a wired network. Examples of wireless networks include, for example, a BLUETOOTH network, a wireless personal area network, a wireless 802. 21 local area network (LAN), and/or wireless telephony network (e.g., a cellular, PCS, or GSM network).

Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, the communication interface 512 can include logic configured to support direct memory access (DMA) transfers between the memory 504 and other devices.

In a networked environment, program modules depicted relative to the hardware device 500, or portions thereof, may be stored in a remote storage device, such as, for example, on a server. It will be appreciated that other hardware and/or software to establish a communications link between the hardware device 500 and other devices may be used.

It should be understood that the arrangement of the hardware device 500 illustrated in FIG. 5 is but one potential implementation and that other arrangements are feasible. It should also be understood that the various system components (and means) defined by the claims, described below, and illustrated in the various block diagrams represent logical components that are configured to perform the functionality described herein. For example, one or more of these system components (and means) may be realized, in whole or in part, by at least some of the components illustrated in the arrangement of the hardware device 500.

In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 5.

Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the descriptions above, the subject matter is described with reference to acts and symbolic representations of operations that are performed by one or more devices, unless indicated otherwise. As such, it is understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is described in a context, it is not meant to be limiting as those of skill in the art will appreciate that various of the acts and operations described hereinafter can also be implemented in hardware.

To facilitate an understanding of the subject matter described above, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A system for enabling authentication by a local identity provider when cloud-based authentication is unavailable, the system comprising:
one or more processors; and
a non-transitory computer readable medium storing a plurality of instructions, which when executed, cause the one or more processors to:
determine whether a system, which is local for a user, is connected to a cloud platform, in response to receiving a request to authenticate the user;
authenticate, by an identity provider on the cloud platform, the user based on identifying a cloud identity assigned to the user, from a plurality of cloud identities associated with subscriptions to access an application, in response to a determination that the system is connected to the cloud platform;
authorize, by a usage service on the cloud platform, the user, authenticated by the identity provider, to access the application based on one of the subscriptions associated with the cloud identity assigned to the user;
match a system user identity with the cloud identity, which were assigned to the user;
authenticate, by an identity manager on the system, the user based on identifying a system identity which is assigned to the user, from multiple system identities matched with multiple cloud identities, in response to a determination that the system is not connected to the cloud platform; and
authorize, by a usage service on the system, the user, authenticated by the identity manager, to access the application based on one of multiple subscriptions associated with one of the multiple cloud identities matched with the system identity assigned to the user.

2. The system of claim 1, wherein authenticating the user further comprises providing an access token to the application, and authorizing the user to access the application is further based on the application providing the access token.

3. The system of claim 1, wherein each subscription is based on the user having at least one of an individual account or a group account subscribed to a product agreement.

4. The system of claim 1, wherein the identity manager authenticating the user is further based on having received prior consent from an administrative user for the user to be authenticated by the identity manager.

5. The system of claim 4, wherein the identity manager authenticating the user is additionally based on the identity manager authenticating the user within an allowed time.

6. The system of claim 1, wherein the plurality of instructions further causes the processor to display, via a graphical user interface associated with the application, an offline mode, a date and time when an administrative user consent expires for authentication by the identity provider, and the system identifier assigned to the user, in addition to the cloud identifier assigned to the user.

7. The system of claim 1, wherein the plurality of instructions further causes the processor to:
cache each event initiated by the user, who was authorized by the usage service on the system, until the system is re-connected to the cloud platform, and
store each cached event to the cloud platform.

8. A computer-implemented method for enabling authentication by a local identity provider when cloud-based authentication is unavailable, the computer-implemented method comprising:
determining whether a system, which is local for a user, is connected to a cloud platform, in response to receiving a request to authenticate the user;
authenticating, by an identity provider on the cloud platform, the user based on identifying a cloud identity assigned to the user, from a plurality of cloud identities associated with subscriptions to access an application, in response to a determination that the system is connected to the cloud platform;
authorizing, by a usage service on the cloud platform, the user, authenticated by the identity provider, to access the application based on one of the subscriptions associated with the cloud identity assigned to the user;
matching a system user identity with the cloud identity, which were assigned to the user;
authenticating, by an identity manager on the system, the user based on identifying a system identity which is assigned to the user, from multiple system identities matched with multiple cloud identities, in response to a determination that the system is not connected to the cloud platform; and
authorizing, by a usage service on the system, the user, authenticated by the identity manager, to access the application based on one of multiple subscriptions associated with one of the multiple cloud identities matched with the system identity assigned to the user.

9. The computer-implemented method of claim 8, wherein authenticating the user further comprises providing an access token to the application, and authorizing the user to access the application is further based on the application providing the access token.

10. The computer-implemented method of claim 8, wherein each subscription is based on the user having at least one of an individual account or a group account subscribed to a product agreement.

11. The computer-implemented method of claim 8, wherein the identity manager authenticating the user is further based on having received prior consent from an administrative user for the user to be authenticated by the identity manager.

12. The computer-implemented method of claim 11, wherein the identity manager authenticating the user is additionally based on the identity manager authenticating the user within an allowed time.

13. The computer-implemented method of claim 8, wherein the computer-implemented method further comprises displaying, via a graphical user interface associated with the application, an offline mode, a date and time when an administrative user consent expires for authentication by the identity provider, and the system identifier assigned to the user, in addition to the cloud identifier assigned to the user.

14. The computer-implemented method of claim 8, wherein the computer-implemented method further comprises:
caching each event initiated by the user, who was authorized by the usage service on the system, until the system is re-connected to the cloud platform, and
storing each cached event to the cloud platform.

15. A computer program product, comprising a non-transitory computer-readable medium having a computer-readable program code embodied therein to be executed by one or more processors, the program code including instructions to:
determine whether a system, which is local for a user, is connected to a cloud platform, in response to receiving a request to authenticate the user;
authenticate, by an identity provider on the cloud platform, the user based on identifying a cloud identity assigned to the user, from a plurality of cloud identities associated with subscriptions to access an application, in response to a determination that the system is connected to the cloud platform;
authorize, by a usage service on the cloud platform, the user, authenticated by the identity provider, to access the application based on one of the subscriptions associated with the cloud identity assigned to the user;
match a system user identity with the cloud identity, which were assigned to the user;
authenticate, by an identity manager on the system, the user based on identifying a system identity which is assigned to the user, from multiple system identities matched with multiple cloud identities, in response to a determination that the system is not connected to the cloud platform; and
authorize, by a usage service on the system, the user, authenticated by the identity manager, to access the application based on one of multiple subscriptions associated with one of the multiple cloud identities matched with the system identity assigned to the user.

16. The computer program product of claim 15, wherein authenticating the user further comprises providing an access token to the application, and authorizing the user to access the application is further based on the application providing the access token.

17. The computer program product of claim 15, wherein each subscription is based on the user having at least one of an individual account or a group account subscribed to a product agreement.

18. The computer program product of claim 15, wherein the identity manager authenticating the user is further based on having received prior consent from an administrative user for the user to be authenticated by the identity manager, and the identity manager authenticating the user within an allowed time.

19. The computer program product of claim 15, wherein the program code includes further instructions to display, via a graphical user interface associated with the application, an offline mode, a date and time when an administrative user consent expires for authentication by the identity provider, and the system identifier assigned to the user, in addition to the cloud identifier assigned to the user.

20. The computer program product of claim 15, wherein the program code includes further instructions to:
cache each event initiated by the user, who was authorized by the usage service on the system, until the system is re-connected to the cloud platform, and
store each cached event to the cloud platform.
